(19) United States
(12) Patent Application Publication
(10) Pub. No.: US 2002/0092495 A1
(43) Pub. Date: Jul. 18, 2002

(54) Manufacturing method of laborsaving engine and engine manufactured by it

(76) Inventor: Jui-Kuang Chen, Miaoli Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/846,178

(22) Filed: May 2, 2001

(30) Foreign Application Priority Data
Apr. 6, 2001 (TW) 90108361
Jan. 12, 2001 (TW) 90200601

(51) Int. Cl. F02B 75/32

(52) U.S. Cl. 123/197.1; 123/197.4

(57) ABSTRACT

The present invention relates to a manufacturing method of laborsaving engine and engine manufactured by it, it comprises a engine mount, cylinder, throttle, spark plug, piston, piston connecting rod, crankshaft and laborsaving device, the laborsaving device further comprises a first laborsaving connecting rod and second labor connecting rod. Wherein one end of the first laborsaving connecting rod is connected on the engine mount, and another end is connected to the piston connecting rod of the cylinder, the second laborsaving is connected to the first laborsaving connecting rod at a proper position, and another end opposite to the connection end of the second laborsaving connecting rod and the first laborsaving connecting rod is connected to the crankshaft, enabling power transmission from the piston connecting rod to the crankshaft to generate a lever action through the disposition of the first and second connecting rods, and further to attain the laborsaving effect of power output of the engine.

### TECHNICAL FIELD

The present invention relates to a laborsaving engine, and more particularly to a laborsaving engine manufacturing method, which can increase an output power effect of an engine, and an engine manufactured by it.

### TECHNICAL BACKGROUND

The engine is one of main structures for outputting mechanical power, after admission, compression, explosion and exhaustion strokes of burning gas in a cylinder, the engine outputs power by means of a connecting rod, crankshaft and etc so as to be used in various types of mechanical transmissions. As shown in FIG. 1, a conventional engine 9 includes a cylinder 90, throttle 91, spark plug 92, piston 93, piston connecting rod 94 and crankshaft 95. After the throttle 91, spark plug 92 and piston 93 in the cylinder 90 are operated in cooperation with four cycle, a resulting power drives the crankshaft 95 through the connecting rod 94, and is then output through the crankshaft 95. For the reason that the piston connecting rod 94 drives the crankshaft 95 directly to generate the power output, and without any other laborsaving mechanisms in the midst of them, it will increase burden on the cylinder in operation, and the abrasive wear of the cylinder will be increased after along term use, if the same power is still maintained, the fuel consumption will consequently become larger. So, under the condition that the power resources are limited, it is necessary to develop and improve such kind of power output mechanism, which is indispensable to human life.

### SUMMARY OF THE INVENTION

It is the primary objective of the present invention to provide a manufacturing method of a laborsaving engine, the process can be utilized to generate a laborsaving engine, which can reduce power consumption.

It is another object of the present invention to provide a manufacturing method of a laborsaving engine, which can increase the power output effect of a engine.

It is still another object of the present invention to provide a manufacturing method of a laborsaving engine, which can save engine fuel under the same output power.

The present invention is characterized in that: a laborsaving device is installed between a piston connecting rod and crankshaft, the laborsaving device at least comprises a first laborsaving connecting rod ′ one end of the first connecting rod is positioned to a engine mount and another end is connected to the engine piston. A second laborsaving connecting rod is connected to a proper position of the first connecting rod, an end opposite to an end connecting the second connecting rod to the first connecting rod is connected to the crankshaft, enabling the power transmission from the piston connecting rod to the crankshaft to generate a lever action by the way of the installment of the first and second connecting rod so as to attain the laborsaving effect of engine power output.

### BRIEF DESCRIPTION OF THE DRAWINGS

FIG. 1 is a schematic view of the conventional engine.

FIG. 2 is an upper schematic view of the present invention, showing a structure of a laborsaving engine made from the method of the present invention.

FIG. 3 is a prospective view of the present invention, showing a structure of a laborsaving engine made from the method of the present invention.

FIG. 4 is a sectional view of the engine of the present invention.

FIGS. 5, 6, 7 and 8 are sectional views, showing operations of the engine of the present invention.

FIG. 9 is a schematic view of another embodiment of the present invention, showing an engine set of the present invention.

FIG. 10 is a schematic view of still another embodiment of the engine of the present invention, showing an engine set of the present invention.

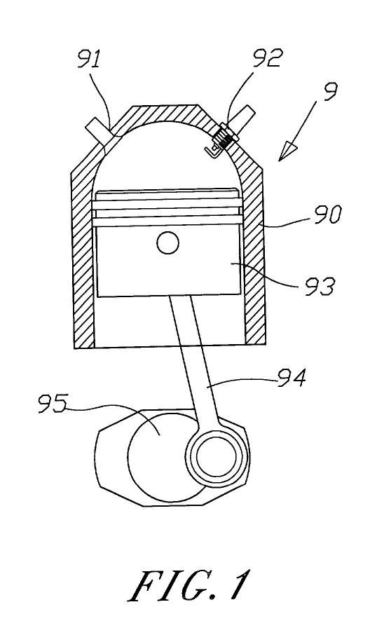

### DETAIL DESCRIPTION OF THE PRESENT INVENTION

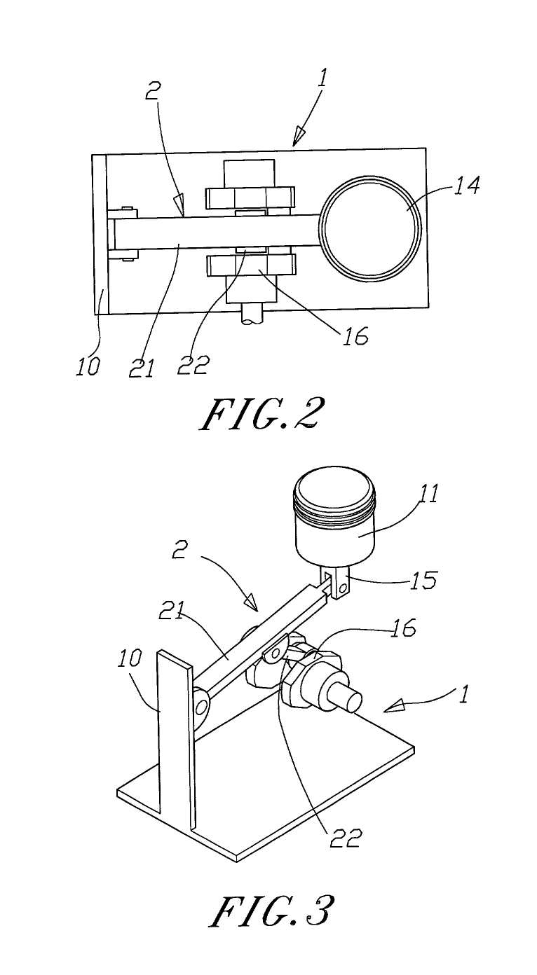

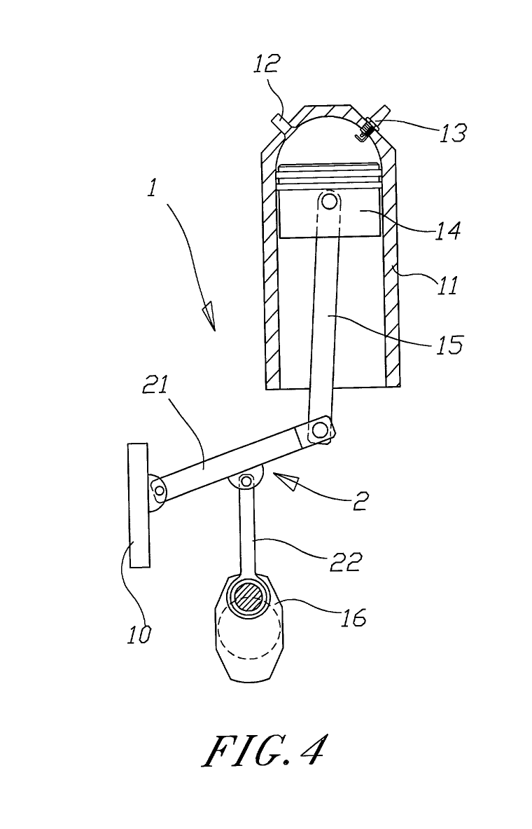

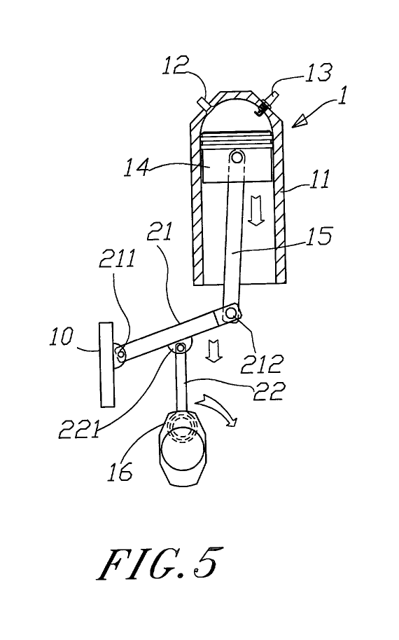

Please refer to FIGS. 2, 3 and 4. The figures illustrate schematic views of the present invention, showing a manufacturing method making a laborsaving engine and an engine made therefrom. A laborsaving engine 1 comprises an engine mount 10, cylinder 11, throttle 12, spark plug 13, piston (reciprocating piston) 14, piston connecting rod 15, crankshaft 16 and laborsaving device 2. The laborsaving device further comprises a first laborsaving connecting rod 21 and second laborsaving connecting rod 22 and the manufacturing method of the engine is described as following:

First step: connect one end of the first laborsaving rod 21 pivotally to a proper position of the engine mount10.

Second step: connect another end of the first laborsaving connecting rod 21 pivotally to one end of the connecting rod 15.

Third step: connect one end of the second laborsaving connecting rod 22 to a proper position of the first laborsaving connecting rod 21.

Fourth step: connect another end of the second laborsaving connecting rod 22 pivotally to the crankshaft 16.

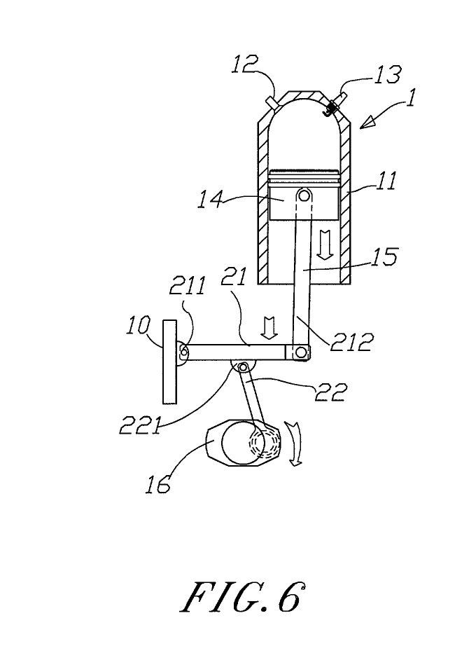

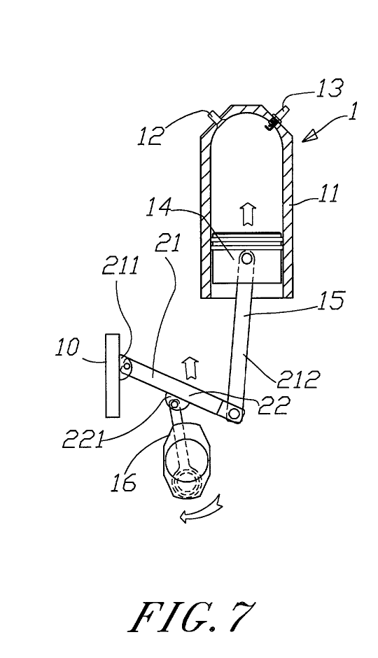

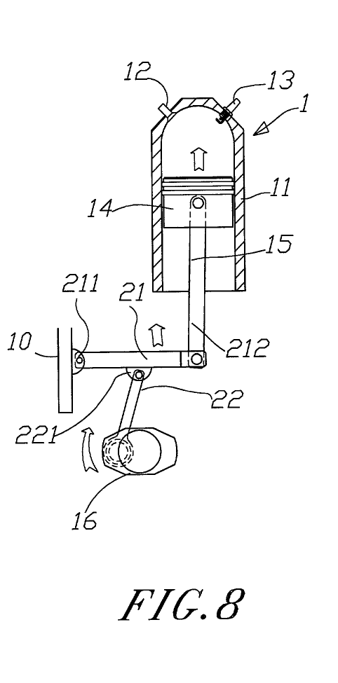

Further, please refer to FIGS. 5, 6, 7 and 8, it shows the operation of the laborsaving engine. In the laborsaving engine assembled from the above-mentioned steps, when the cylinder drives the connecting rod 15 to move through four cycle. As FIG. 5 shown, the first laborsaving connecting rod 21 takes a pivoting end 211 of it and the engine mount 10 as a supporting point, and is driven by the connecting rod 15 at a pivoting end 212. Meanwhile, the second laborsaving connecting rod 22 is driven by the first laborsaving connecting rod 21 through a pivoting end 221 of it and the first laborsaving connecting rod 21, and so, the crankshaft 16 will further be driven to move, because another end of the second laborsaving connecting rod 22 is pivoted to the crankshaft 16. As shown in FIG. 6, when the piston 14 continues to move forward, the connecting rod will continue to drive the first laborsaving connecting rod 21 downward, and further to drives the second laborsaving connecting rod 22, enabling the crankshaft 16 to be driven to rotate and to complete the operation that the crankshaft 16 is driven in the explosion and exhaustion strokes of the cylinder 11. Furthermore, as FIGS. 7 and 8 shown, the inertia of the crankshaft 16 will force the piston to progress admission and compression strokes in the cylinder 11 along an anti-direction through the laborsaving device, and complete the operation of one cycle of the cylinder. Therefore, by way of the connection and transmission between the connecting rod 15 and the first connecting rod 21 and the second connecting rod 22, the crankshaft 16 is driven to rotate and power is output continuously, the laborsaving device 2 can bring lever action into play, and effect of the laborsaving engine can be attained.

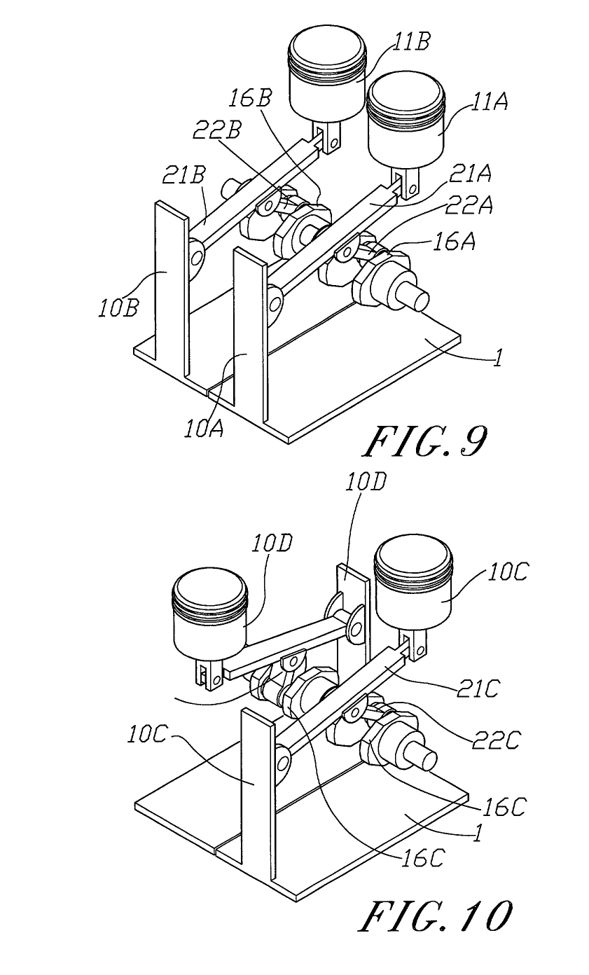

Furthermore, refer to FIG. 9, it shows another embodiment of the laborsaving device of the present invention applied on multiple cylinders. Cylinders 10A and 10B of first laborsaving connecting rods 21A and 21B are pivoted to engine mounts 10A and 10B at the same direction respectively. Again, power is transmitted to crankshafts 16A and 16B through second laborsaving connecting rods 22A and 22B, so as to attain the lever laborsaving effect of the multiple cylinders. Refer to FIG. 10, it shows still another embodiment of the laborsaving device of the present invention applied on multiple cylinders. Cylinders 10C and 10D of first laborsaving connecting rods 21C and 21D are pivoted to engine mounts 10C and 10D at the anti-direction respectively. Again, power is transmitted to crankshafts 16C and 16D through second laborsaving connecting rods 22C and 22D, so as to attain the lever laborsaving effect of the multiple cylinders, and to balance the engines at both sides to increase the stabilization of the operations of the engines.

The present invention at least has the effect as following:

1. The assemblage of a laborsaving engine can be achieves through the steps of the present invention.

2. The effect of power output of an engine can be enhanced through the structure design of the laborsaving device, and effect of laborsaving can be brought into light to reduce the burden of the engine.

3. Under the same condition outputting same power, the present invention rather can reduce the consumption of cylinder fuel, and save energy.

The above disclosure is not intended as limiting. Those skilled in the art will readily observe that the numerous modifications and alternations of the device may be made while retaining the teachings of the invention. Accordingly, the above disclosure should be construed as limited only by the metes and bounds of the appended claims.

1. A manufacturing method of laborsaving engine, comprising an engine mount, cylinder, throttle, spark plug, piston, piston connecting rod, crankshaft and laborsaving device, said laborsaving device further comprising a first laborsaving connecting rod and second laborsaving connecting rod, and being assembled by following steps:
First step: connecting one end of said first laborsaving rod pivotally to a Proper position of said engine mount;
Second step: connecting another end of said first laborsaving connecting rod Pivotally to one end of the connecting rod;
Third step: connecting one end of said second laborsaving connecting rod to a Proper position of said first laborsaving connecting rod; and
Fourth step: connecting another end of said second laborsaving connecting rod Pivotally to said crankshaft:

2. The method of claim 1, wherein said first and second steps can be change in operation sequence.

3. The method of claim 1, wherein said third and fourth steps can be change in operation sequence.

4. A laborsaving engine device, comprising an engine mount, cylinder, throttle, spark plug, piston, piston connecting rod, crank shaft and laborsaving device, said laborsaving device further comprising a first laborsaving connecting and second laborsaving connecting rod, wherein one end of said first laborsaving connecting rod is connected on said engine mount, and another end is connected to said piston connecting rod of said cylinder, said second laborsaving is connected to said first laborsaving connecting rod at a proper position, and another end opposite to the connection end of said second laborsaving connecting rod and said first laborsaving connecting rod is connected to said crankshaft, enabling power transmission from said piston connecting rod to said crankshaft to generate a lever action through the disposition of said first and second connecting rods, and further to attain the laborsaving effect of power output of said engine.

5. The device of claim 4, wherein said first laborsaving connecting is pivoted to said engine mount.

6. The device of claim 4, wherein said first laborsaving connecting is pivoted to said piston connecting rod.

7. The device of claim 4, wherein said second laborsaving connecting rod is pivoted to said first laborsaving connecting rod.

8. The device of claim 4, wherein said second laborsaving connecting rod is connected to said crankshaft.

9. The device of claim 4, wherein said laborsaving device is applicable on the operation of multiple cylinders.

10. The device of claim 9, wherein said multiple cylinders are disposed on said engine mounts in anti-direction so as to increase the stabilization of the operation of said engines and said laborsaving devices.
